(19) United States
(12) Patent Application Publication
(10) Pub. No.: US 2006/0075203 A1
(43) Pub. Date: Apr. 6, 2006

(54) Configurable memory partitioning in hardware

(75) Inventor: Santanu Dutta, Sunnyvale, CA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/538,371

(22) PCT Filed: Dec. 9, 2003
(86) PCT No.: PCT/IB03/05797

§ 371 Date: Jun. 13, 2005

Related U.S. Application Data
(60) Provisional application No. 60/432,756, filed on Dec. 12, 2002.

(51) Int. Cl. G06F 12/00

(52) U.S. Cl. 711/173

(57) ABSTRACT

A buffer management system (100) partitions a total memory space (200) into a programmable number of substantianially uniform size buffers (220-223). An application communicates the desired number of buffers to the buffer management system (200), then allocates these buffers among the data-transfer paths used by the application. Optionally, multiple uniform-size buffers can be merged to form a single logical buffer. By effecting the partitioning of the total memory space (200) into uniform-size buffers (220-223), the overhead required to manage the multiple buffers is minimized. By providing a selected number of managed buffers to an application, the application is able to allocate buffers as required, without having to be concerned with the details of buffer management.

This invention relates to the field of electronics, and in particular to a memory system that is configurable to provide multiple independent read/write buffers.

Buffers are commonly used to temporarily store data as it is passed from a source to a destination. The temporary storage of such data allows for the asynchronous operation of the source and destination, allows for short periods of speed-mismatch between the source and destinations, provides an efficient means of regulating the data-transfer rate of the source without loss of data, and so on.

Initially, data from the source is written to the buffer as quickly as the source can provide it, and read from the buffer as quickly as the destination can accept it. If the source is slower than the destination, the destination must wait for the data to become available in the buffer. If the source is faster than the destination, it continues to provide data to the buffer until the buffer becomes full, or near full, at which point the source is commanded to cease transmission until the destination removes data from the buffer to create space for the source data. By allowing the reception of data from the source at the source's transfer rate until the buffer is full, intermittent higher-than-average transfer rates are supported, and intermittent reception delays at the destination are not necessarily propagated to the source. The amount of intermittent differences in source and destination transfer speeds that can be accommodated without affecting the overall data transfer rate is dependent upon the size of the buffer, a large buffer being able to accommodate larger differences than a small buffer.

The size of the buffer is generally determined based on the characteristics of either the source or the destination, or both, particularly with regard to the intermittent nature of their data transfer speeds. If the source and destination each have uniform transfer rates, little buffering is required. If the source provides bursts of data, or the destination processes the data in blocks, the buffer is generally sized to accommodate the size of the bursts or blocks.

Most systems include a plurality of sources and destinations, and a plurality of buffers are used to facilitate the data transfer between each source and destination. In most cases, the total amount of memory is limited, and the amount of memory allocated to each buffer is determined based on the aforementioned characteristics of the sources and destinations, as well as the relative priority associated with maintaining a high transfer rate between particular sources and destinations, and other performance factors. In many instances, however, applications are run on such systems that do not utilize all of the sources and/or destinations that the system is designed to support, and the buffers associated with these sources and/or destinations are unused. In like manner, different applications may associate different priorities with transfers between particular sources and destinations, and the distribution of sizes of the buffers may be inconsistent with the desired priorities.

Fully configurable partitioning of a memory can be provided to an application by providing the entire buffer memory space to the application, and having the application logically partition the memory into individually sized-buffers. Such an approach, however, generally requires that the application handle all of the aspects of buffer-management. Alternatively, the system may retain responsibility for handling the buffer-management, while also allowing for programmable buffer sizes. In such an embodiment, however, the system overhead that is associated with managing an unknown combination of varying buffer sizes can be cost-prohibitive and/or may introduce processing delays that degrade the system's performance.

It is an object of this invention to provide a buffer management system that allows for configurable memory partitioning with minimal overhead. It is a further object of this invention to provide a buffer management system that is easy to control and use. It is a further object of this invention to provide a buffer management system that is suitable for implementation in a hardware device.

These objects, and others, are achieved by providing a buffer management system that partitions a total memory space into a programmable number of substantially uniform-size buffers. An application communicates the desired number of buffers to the buffer management system, then allocates these buffers among the data-transfer paths used by the application. Optionally, multiple uniform-size buffers can be merged to form a single logical buffer. By effecting the partitioning of the total memory space into uniform-size buffers, the overhead required to manage the multiple buffers is minimized. By providing a selected number of managed buffers to an application, the application is able to allocate buffers as required, without having to be concerned with the details of buffer management.

The invention is explained in further detail, and by way of example, with reference to the accompanying drawings wherein:

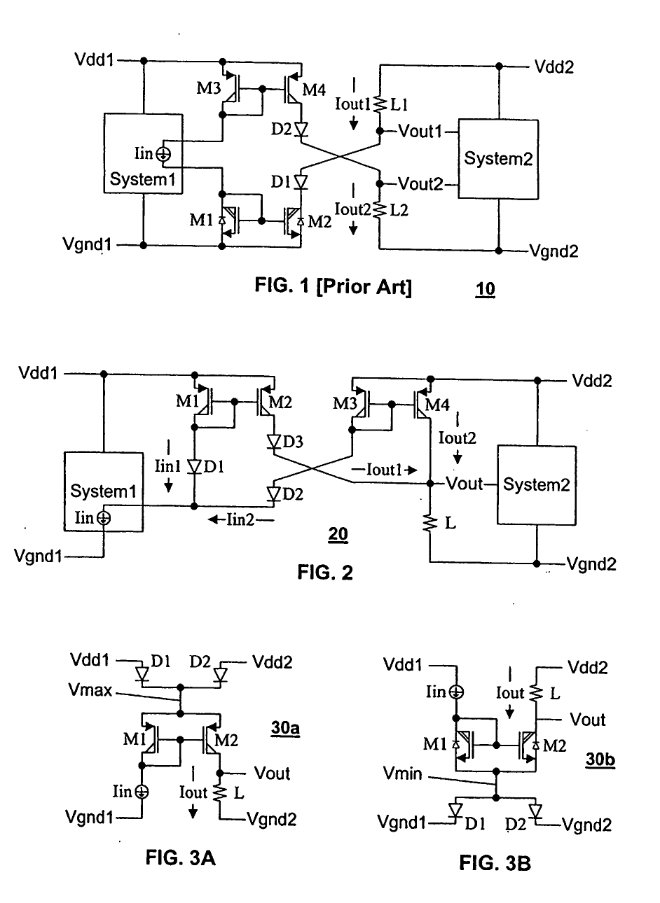

FIG. 1 illustrates an example block diagram of a buffer management system in accordance with this invention.

FIG. 2 illustrates an example partitioning of a memory space into uniform-size buffers in accordance with this invention.

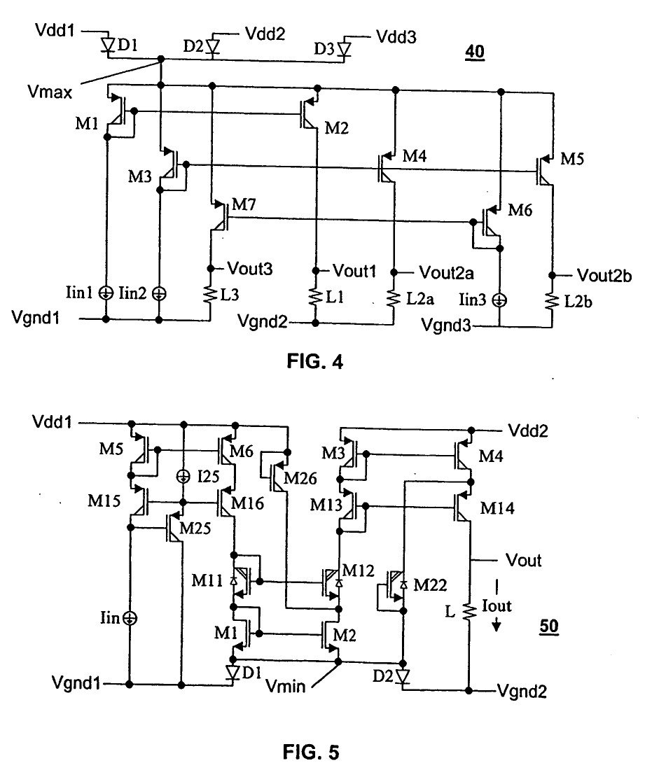

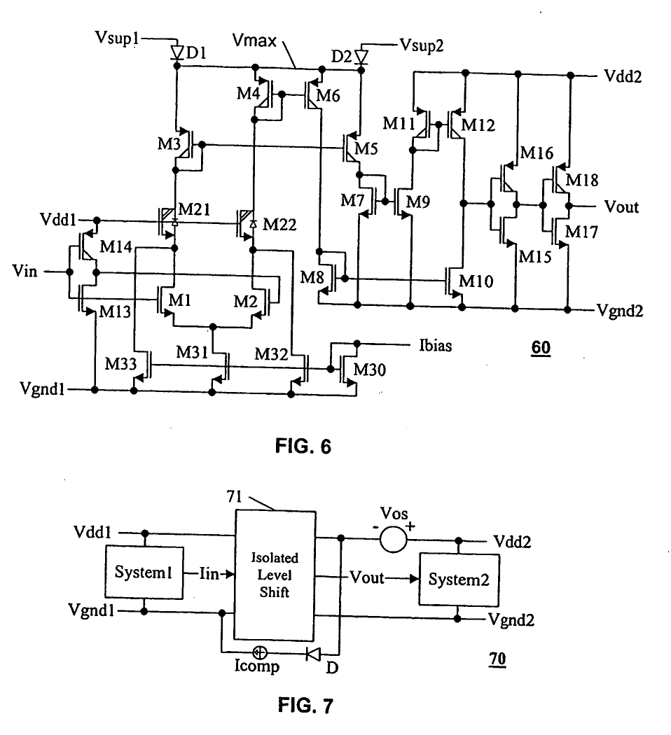

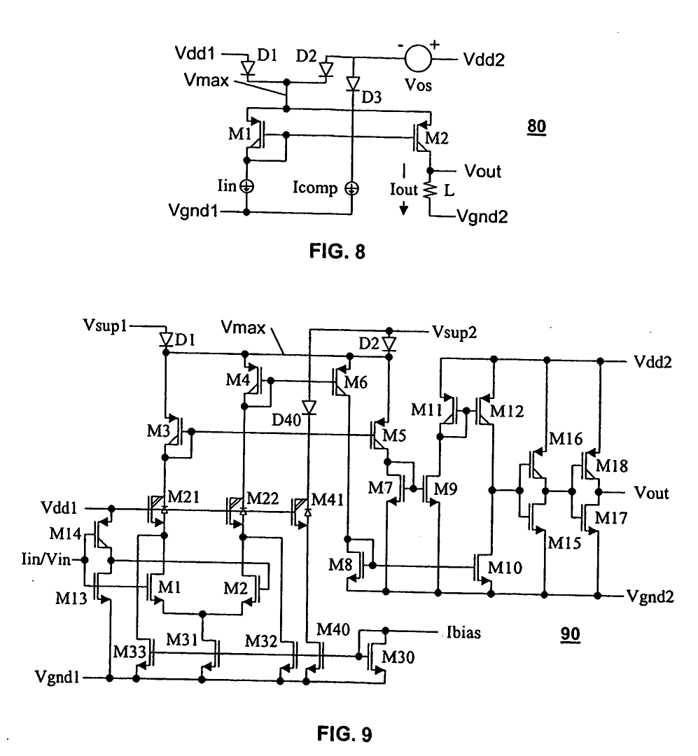

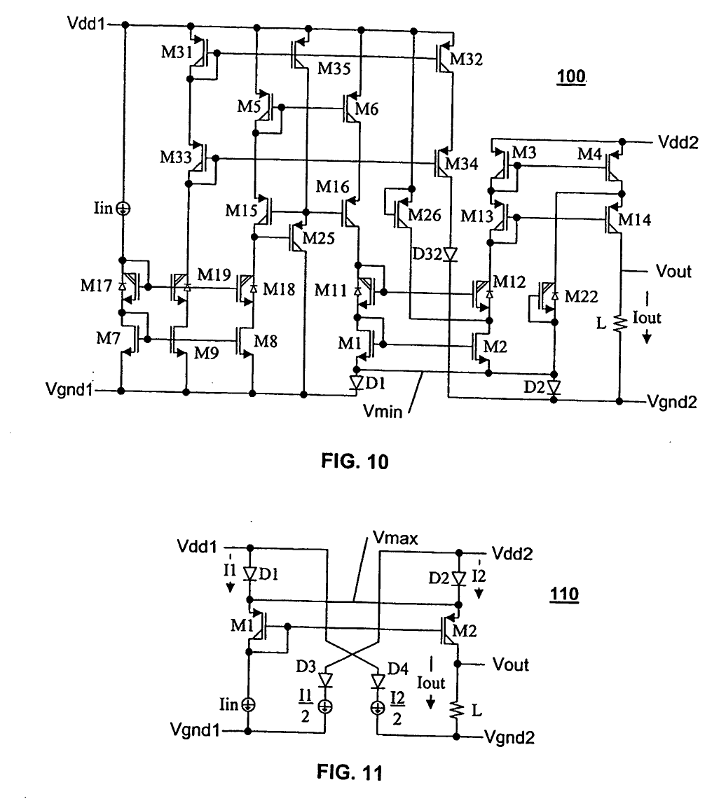

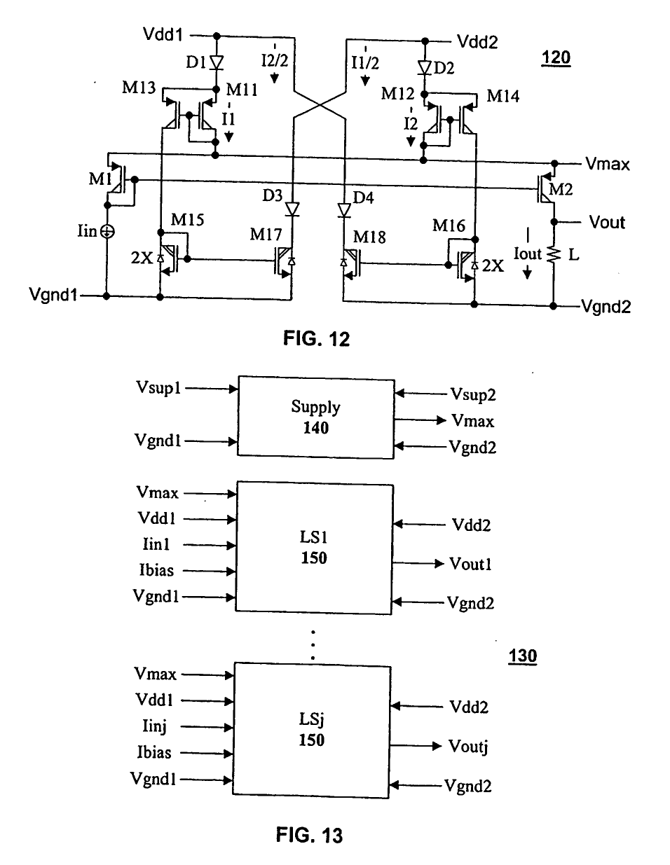

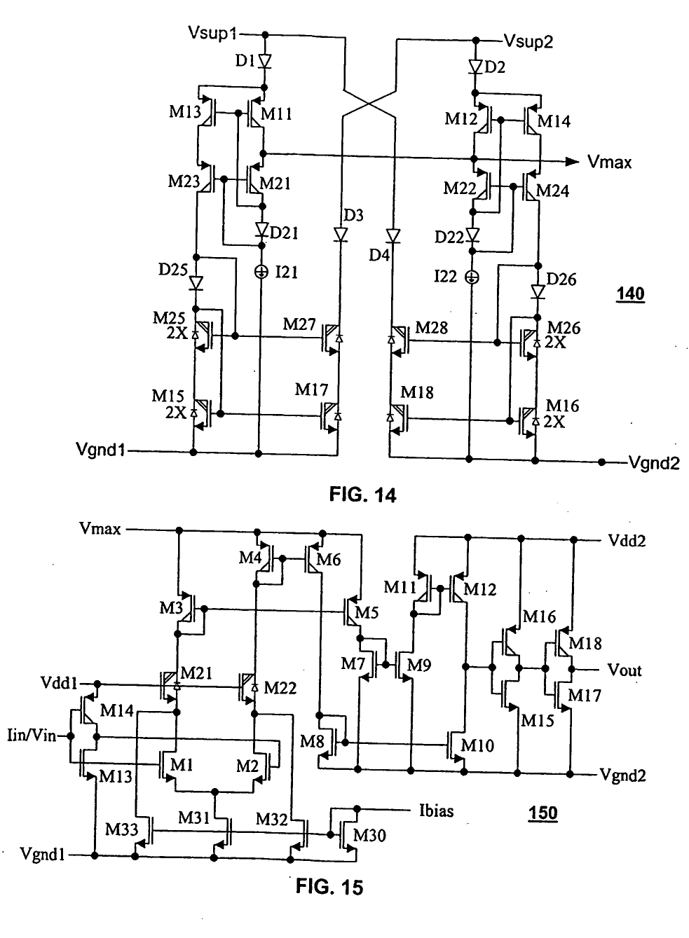

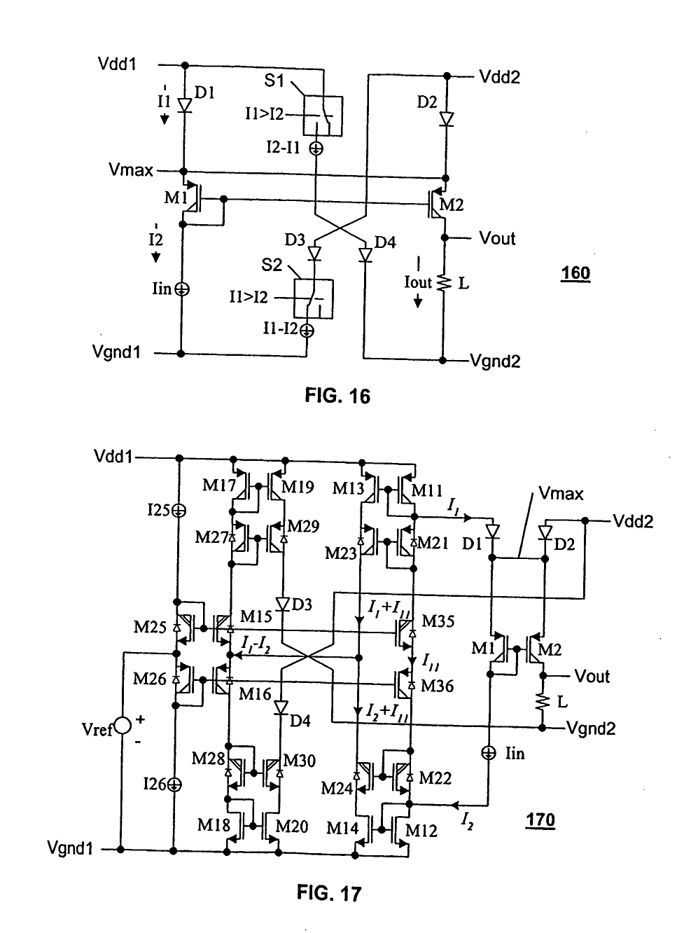

FIG. 3 illustrates an example structure of a buffer addressing scheme for use in a partitioned buffer system in accordance with this invention.

Throughout the drawings, the same reference numerals indicate similar or corresponding features or functions.

FIG. 1 illustrates an example block diagram of a buffer management system 100 in accordance with this invention. The buffer management system 100 comprises a controller 150 that is configured to control write control logic 130 and read control logic 140, to facilitate the transfer of data from one or more sources 110 to one or more destinations 120. Although illustrated as separate control blocks 130, 140, and 150, for ease of understanding, the control blocks 130 and 140 are typically components of the controller 150. As is common in the art, a device that can both send and receive data would be included as both a source 110 and a destination 120. For ease of reference, a source-destination path is herein defined as a conduit to effect the transfer of data from a particular source to a particular destination, or from a plurality of sources to a particular destination, or from a particular source to a plurality of destination, or from a plurality of sources to a plurality of destinations. That is, a buffer within a source-destination path may receive only data from one source to one destination, or it may receive all of the data addressed to one destination, or it may receive all of the data sent from one source, or it may receive all of the data from multiple sources to multiple destinations.

One or more applications (not shown) initiate the transfers between the sources 110 and destinations 140. Depending upon the particular application, different source-destination paths may be defined, different priorities may be assigned to each path, different traffic patterns may be exhibited, and so on. In accordance with this invention, the controller 150 structures the partitioning of a buffer memory 200 into independent buffers, depending upon the requirements of the one or more applications for effective and efficient data transfer among the different source-destination paths.

As will be evident to one of ordinary skill in the art in view of this disclosure, this invention is particularly well suited for implementations wherein the applications that will be transferring data across the various source-definition paths are known a priori, but the total number of destination ports is determined by the application at run-time. For example, the buffer memory 200, the write control logic 130, the read control logic 140, and the controller 150 may be embodied as pre-defined “library” elements in a hardware design system. When a custom-designed integrated circuit is created using these library elements, the controller 150 effects a partitioning of the buffer memory 200 to support the applications that are embodied in the integrated circuit, or embodied in a system that includes this integrated circuit. In another example, the buffer management system 100 may be included in a programmable device or system that can run a variety of applications, and the controller 150 effects a partitioning of the buffer memory 200 when the particular set of applications are programmed into the programmable device.

In a preferred embodiment of this invention, the controller 150 receives a parameter that specifies the number of buffers that are required from the buffer memory 200. Based on this parameter, hereinafter termed the partition parameter, the controller 150 partitions the buffer memory 200 into a number of equal-size buffers, wherein the equal-size, k, of the buffers is a power of two. In a preferred embodiment of this invention, the number of partitions is also a power of two, as illustrated in FIG. 2.

In FIG. 2, the memory 200a comprises a single buffer B0, corresponding to a partition parameter of one; the memory 200b comprises two buffers, B0 210 and B1 211, corresponding to a partition parameter of two. The memory 200c comprises four buffers 220, 221, 222, 223, corresponding to a partition parameter of three or four. In the general case, illustrated by the memory 200d, the memory 200 of FIG. 1 is partitioned into “n” equal-size buffers, where “n” is an integer power of two (n=2^{N}), corresponding to a partition parameter between 2^{N-1}+1 and n.

For ease of understanding, the invention is presented initially for the example case of the partition parameter being equal to n, where n is a power of 2 (n=2^{N}). Thereafter, examples of partition parameters of less than 2^{N} are presented.

Data from a source is inserted at, or written to, a next-available write location, and removed from, or read from, a last-unread read location to a destination. The write control logic 130 assures that the next-available write location is unused, wherein “unused” is defined as not containing data that has yet to be read out to the destination. If the buffer is “full”, such that the entire buffer contains data that has yet to be read out to the destination, the write to the buffer is delayed until the oldest, or last-unread, data is read out to the destination, thereby freeing an available space in the buffer. The read control logic 140 assures that data is available that has not yet been read out to the destination; otherwise, the read operation is stalled.

In a conventional buffer system, as in this invention, each buffer B0, B1, . . . is configured as a circular buffer, wherein the “next” location after the “end”, or “top”, of the buffer is the “start”, or “bottom”, of the buffer. The write control logic 130 and read control logic 140 are configured to effect this circular addressing simultaneously in multiple buffers. The following pseudo-code effects a circular-increment function for a single buffer:

function next_address(current_address, buffer_start, buffer_end)

if current_address < buffer_end

then next_address == current_address + 1
else next_address == buffer_start.

In the example of buffer memory 200 with n buffers, the function next₁₃address can be defined as:

function next_address(current_address, buffer_index)

if current_address < buffer_end[buffer_index]

then next_address == current_address + 1
else next_address == buffer_start[buffer_index];

wherein buffer_start and buffer_end arrays contain the start and end location of each buffer, and are locally known to the function. Using this form of the function, the incrementing of a write pointer (wp) to a buffer “j” of the n buffers is effected via the following command:
wp[j]=next₁₃address(wp[j],j).

In like manner, the incrementing of the read pointer (rp) to buffer “j” is effected via the following command:
rp[j]=next₁₃address(rp[j], j).

A write to a buffer j can defined by the following pseudocode:

function write(data, j)

If OK_to_write(j)

| then: | buffer[wp[j]] == data |
|---|---|
| | wp[j] == next_address(wp[j],j) |
| | write == SUCCESS; |
| else: | write == FAILURE; |

wherein in this model, the write pointer wp points to the next available location in the buffer to place data, and is locally known to this function. The OK₁₃to₁₃write function is a conventional checking function that verifies that the buffer is not full, based on a comparison of the read and write pointers. In this example, if the write function returns a FAILURE, the source is directed not to send additional data, and the write function is repeatedly called by the application until a SUCCESS is returned, and the source is again enabled to send another data item. As is known in the art, if there is a substantial time lag between the source and the buffer, the source may be disabled from sending additional data whenever the buffer becomes “nearly full”, using a threshold number of data slots to define “nearly full”.

A read from the buffer j can defined by the following pseudocode:
function read (j)
   loop here until OK₁₃to₁₃read (j);
   read=buffer[rp[j]]
   rp[j]=next₁₃address(rp[j],j]); wherein in this model, the read pointer rp points to the next potentially available location in the buffer to read data from. The OK₁₃to₁₃reads) function is a conventional checking function that verifies that data has been written to the buffer and not yet read out. In this example, the read function waits in its internal loop until the OK₁₃to₁₃read function indicates that there is data to be read in the buffer.

Note that, in the examples given above, the writing to or reading from one of n buffers by an application merely requires a single function call, thereby keeping the complexity of the application to a minimum. In accordance with this invention, the application merely notifies the controller 150 of its need for buffers, and thereafter need only allocate each buffer to each source-destination data path, using the aforementioned buffer index (“j” in the above example). Each read or write along the various paths is effected by performing a read or write to the corresponding indexed buffer. As indicated by the dashed arrow of FIG. 1, the identification of the path for a data transfer is often contained within the data that is being transferred, such as via the use of a destination field within the data. In such an example, the controller 150 provides the appropriate mapping to the write control logic 130 for effecting the translation of the destination field in the data to the buffer index corresponding to the identified destination. In such an embodiment, an explicit “write” function call need not be contained in the application, the write function being implicitly invoked by the arrival of a data packet containing a destination field, and the buffer index being automatically calculated from the data itself.

Note also that, in the examples given above, each read or write operation, whether explicit or implicit, requires a call to the next₁₃address function. Therefore, the complexity of the next₁₃address function will have a direct effect on the achievable throughput of the buffer management system 100. The next₁₃address function, as given above, requires conditional tests, comparisons, and assignments based on the indexed contents of the buffer₁₃start and buffer₁₃end arrays. Furthermore, the next₁₃address function, as given above, requires the storage of these arrays, or similar structures. One of ordinary skill in the art will also recognize that the above next₁₃address function is not particularly well suited for implementation in hardware.

In accordance with this invention, the next₁₃address function is optimized to eliminate the conditional tests, as well as the comparisons and assignments based on the indexed contents of the buffer₁₃start and buffer₁₃end arrays, thereby providing a function that is particularly well suited for hardware implementation. In a preferred embodiment, the buffer₁₃start and buffer₁₃end arrays are also eliminated.

As noted above, in accordance with this invention, each of the n equal-size buffers has a size “k” that is an integer power of 2 (k=2^{Z}). Defining the beginning of a buffer memory 200 of size 2^{M} as address zero, and assuming that each of the n equal-size buffers are contiguous in the buffer memory 200 starting at address zero and ending at 2^{M}−1, limiting each buffer to a size k of 2^{Z} has the following advantageous results:
the lower order Z bits of an address will correspond to a unique location in each of the buffers (from 0 to 2^{Z}−1) and,
the upper order M-Z bits will correspond to the aforementioned index to each of the buffers (from 0 to n−1).

FIG. 3 illustrates an example structure of a buffer addressing scheme for use in a partitioned buffer system in accordance with this invention. As noted above, the buffer memory 200 is assumed to be of size 2^{M}, and therefore M bits are used to uniquely address each of the memory locations within the buffer memory 200. Of these M bits, N bits are required to index up to 2^{N} buffers. The remaining M-N bits are then available for directly addressing within each of the 2^{N} buffers, because, as noted above, the lower order Z(=M-N) bits of the address correspond to a unique location within a buffer of size 2^{Z}.

Using the structure illustrated in FIG. 3, the pseudocode for implementing a circular-increment function is given as:
function next₁₃address(current₁₃address, buffer₁₃index)
   next₁₃address=current₁₃address+1
   next₁₃address{upper N bits}=buffer₁₃index; wherein the bracketed notation indicates that the upper N bits of the next₁₃address are replaced by the given buffer₁₃index.

One of ordinary skill in the art will recognize that the above function is particularly well suited for implementation in hardware. The first statement merely corresponds to an address-increment function, applied to the entire contents of the current₁₃address. If the current₁₃address is at the end of the allocated buffer space in the buffer memory 200, this increment function will cause a ‘carry’ into the buffer index field (the upper N bits) of the structure of FIG. 3, which, absent the next statement, would cause the next₁₃address to be erroneously associated with the next adjacent buffer. The second statement, however, is a bit-overwrite function that automatically cures such an erroneous association by assuring that the next₁₃address is returned with the proper buffer₁₃index in the buffer index field. In hardware, this statement is effected via one or two bit-masking operations.

One of ordinary skill in the art will also recognize that the structure of FIG. 3 provides the maximum available memory to each of the equal-size buffers. If only one buffer is required, N equals zero, and the entire buffer memory 200 is allocated to this buffer. If only two buffers are required, N equals one, and each buffer is provided half of the total buffer memory 200. If four buffers are required, N equals two, and each buffer is provided a quarter of the total buffer memory 200, and so on, as illustrated in FIG. 2.

In a typical hardware embodiment, the aforementioned “library” elements will include a large buffer memory 200. In an application involving few source-data paths, each of the source-data paths are allocated large segments of this buffer memory 200, thereby potentially providing high throughput rates. In an application involving many source-data paths, each of the paths are provided smaller segments of this buffer, and the throughput is likely to be limited, as is generally inherent in applications with many source-data paths, but this application will be supported without necessitating a redesign of the library elements.

That is, by partitioning a memory space into equal-sized buffers of a size that is an integer power of 2, an efficient and effective buffer management system can be provided with minimal overhead required for managing multiple circular buffers, and with minimal overhead to partition and allocate the total available buffer memory.

One of ordinary skill in the art will recognize that although the buffers are of equal-physical-size, an application may logically associate multiple equal-physical-size buffers to one logical buffer, and allocate this larger logical buffer to a particular source-destination path. For example, the application could allocate buffers B0, B1, and B2 of buffer memory 200c of FIG. 2 to one path, and buffer B3 to another. Data transfers via the first path could be effected via a round-robin writing to and reading from each of the buffers: B0, B1, B2, B0, B1, and so on. Alternatively, if there are more buffers than source-destination paths, the application could be configured to hold one or more buffers “in reserve”, and dynamically allocate these buffers as required when particular paths experience a high level of write-failures due to sudden bursts of traffic. These and other techniques for using the advantages provided by this invention will be evident to one of ordinary skill in the art.

The principles of this invention may also be embodied using unequal-size buffers, albeit with a slight increase in complexity. Consider, for example, partitioning the buffer memory 200 into three buffers. In the example partitioning of memory 200c into four buffers, two bits are required for buffer indexing, using the combinations of: 00, 01, 10, and 11. Each of these combinations uniquely identifies one of the buffers B0, B1, B2 and B3 of 200c. Three buffers also require two bits for buffer indexing, but using the algorithms detailed above, one of the index bit combinations would go unused, and thus one of the partitions would not be available for use.

In this alternative embodiment, however, a buffer index can correspond to a plurality of bit combinations. That is, for example, buffer B0 could correspond to index bit combination 00, buffer B1 to index bit combination 01, and buffer B2 to either bit combination 10 or 11. In this manner, buffers B0 and B1 will each be allocated a quarter of the buffer memory 200, and buffer B2 will be allocated half of the buffer memory 200. Such a multiple allocation of index bit combinations can be implement via the introduction of a “don't care” bit-masking operation, common in the art. That is, using the symbol “−” to identify a “don't care” bit, the index bit assignments given above are specified as: B0=00, B1=01, and B2=1−. Using this specification, the above bit assignment statement that stored the buffer index into the upper N bits of the next₁₃address is modified to only replace the specified bits, and not the “don't care” bits. The following example pseudocode for a hardware description of a buffer management system that allows a partitioning of a buffer memory with an address space of 8 bits (0-7) into one, two, three, or four buffers illustrates this technique.

Address increment:

case (no. of buffers)

1: ptr[7:0]+1;
2: case (buffer index)

0:ptr0[7:0] <= {0,ptr0[6:0]+1};
1:ptr1[7:0] <= {1,ptr1[6:0]+1};
endcase

3: case (buffer index)

0:ptr0[7:0] <= {00,ptr0[5:0]+1};
1:ptr1[7:0] <= {01,ptr1[5:0]+1};
2:ptr2[7:0] <= {1, ptr2[6:0]+1};
endcase

4: case (buffer index)

0:ptr0[7:0] <= {00,ptr0[5:0]+1};
1:ptr1[7:0] <= {01,ptr1[5:0]+1};
2:ptr2[7:0] <= {10,ptr2[5:0]+1};
3:ptr3[7:0] <= {11,ptr3[5,0]+1};
endcase

endcase.

In this example pseudocode, the “<=” symbol indicates a transfer of the contents on the right of the symbol to the register on the left of the symbol, and the curled brackets indicate a bit-oriented operation, wherein the first argument indicated the values that the upper most significant bits receive, and the second argument indicates the values that the indicated least significant bits receive.

In the case of three buffers in the above pseudocode, when the pointer to buffer B0 (ptr0) is being incremented, the upper two bits of the pointer are forced to be 00; when the pointer to buffer B1 (ptr1) is being incremented, the upper two bits of the pointer are forced to be 01; but when the pointer to buffer B2 (ptr2) is being incremented, only the upper most bit of the pointer is forced to be a 1, the second most significant bit being controlled by the second argument of the bit-oriented operation. That is, the lower 7 bits (from bit 6 to bit 0) of the pointer to buffer B2 (ptr2) progress through a normal counting cycle, whereas only the lower 6 bits (from bit 5 to bit 0) of the pointers to buffers B0 and B1 (ptr0 and ptr1) progress through a normal counting cycle. Other combinations of “don't care” index bits can easily be defined to provide for unequal buffer sizes. For example, a set of indexes of: (00-, 01-, 1-0, 101, 111) corresponds to buffers of size (¼, ¼, ¼, ⅛, ⅛) of the total buffer memory 200.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

1. A buffer management system, comprising: a buffer memory, and a controller , operably coupled to the buffer memory, that is configured to partition the buffer memory into a plurality of independent buffers, dependent upon a partition parameter that determines a quantity of the plurality, wherein each buffer of the plurality of independent buffers has a buffer-size that is an integer power of two, to facilitate circular-access to the buffer.

2. The buffer management system of claim 1, wherein the controller is configured to include a circular-increment function that requires only an address-increment function and a bit-overwrite function to effect a circular-increment of a pointer to a select buffer of the plurality of independent buffers.

3. The buffer management system of claim 1, wherein the buffer-sizes of the plurality of independent buffers are equal.

4. The buffer management system of claim 1, wherein the controller is further configured to allocate the plurality of independent buffers among a plurality of source-destination paths.

5. The buffer management system of claim 1, wherein the controller is further configured to provide a write-interface and a read-interface to one or more applications, the write-interface requiring only an identification of data to be stored and an identification of a select buffer of the plurality of independent buffers to store the data, and the read-interface requiring only the identification of the select buffer.

6. The buffer management system of claim 1, wherein the buffer memory is addressed by an M-bit address, each buffer of the plurality of independent buffers is indexed by an N-bit index that forms a set of N most-significant-bits of the M-bit address, and the size of each buffer is at least 2^{M-N}.

7. A method of managing a buffer memory, comprising: receiving a partition parameter, partitioning the memory buffer into a plurality of independent buffers, wherein the plurality is determined from the partition parameter, and a size of each buffer of the plurality of independent buffers is an integer power of two, thereby facilitating circular-addressing of each buffer.

8. The method of claim 7, wherein the sizes of the plurality of independent buffers are equal.

9. The method of claim 7, further including providing circular-addressing for each buffer, wherein the circular-addressing includes: incrementing an address to the buffer memory, and overwriting select bits of the address, corresponding to an index to the buffer within the buffer memory.

10. The method of claim 7, further including: providing a write-interface that requires only an identification of data to be stored and an identification of a select buffer of the plurality of independent buffers to store the data, and providing a read-interface that requires only the identification of the select buffer.

11. The method of claim 7, wherein the buffer memory is addressed by an M-bit address, each buffer of the plurality of independent buffers is indexed by an N-bit index that forms a set of N most-significant-bits of the M-bit address, and the size of each buffer is at least 2^{M-N}.

12. An integrated circuit, comprising a buffer memory, and a controller that includes write control logic, and read control logic, wherein the controller is configured to partition the buffer memory into a plurality of buffers, based on a partition parameter that is provided to the controller, each buffer of the plurality of buffers having a size that is an integer power of two, and the write control logic and read control logic are each configured to facilitate use of each buffer as a circular buffer.

13. The integrated circuit of claim 12, wherein the sizes of the plurality of buffers are equal.

14. The integrated circuit of claim 12, wherein the use of each buffer as a circular buffer requires circular-addressing, and the controller is configured to effect the circular-addressing via an incrementer that is configured to increment an address to the buffer memory, and a bit masker that is configured to overwrite select bits of the address, corresponding to an index to the buffer within the buffer memory.

15. The integrated circuit of claim 12, wherein the write control logic effects a storage of a data value to a select buffer of the plurality of buffers based only on an identification of the data value and an identification of the select buffer, and the read control logic effects a retrieval of the data value based only on the identification of the select buffer.

16. The integrated circuit of claim 12, wherein the buffer memory is addressed by an M-bit address, each buffer of the plurality of independent buffers is indexed by an N-bit index that forms a set of N most-significant-bits of the M-bit address, and the size of each buffer is at least 2^{M-N}.
